(19) United States
(12) Patent Application Publication
(10) Pub. No.: US 2023/0296199 A1
(43) Pub. Date: Sep. 21, 2023

(54) Hose Bib Lock With Keyless Removal Function

(71) Applicant: Mark Nickeas, Thousand Oaks, CA (US)

(72) Inventor: Mark Nickeas, Thousand Oaks, CA (US)

(21) Appl. No.: 17/700,473

(22) Filed: Mar. 21, 2022

(51) Int. Cl. F16L 55/115

(52) U.S. Cl. CPC F16L 55/1157

(57) ABSTRACT

A hose bib lock with keyless removal function (HBLKRF) that is placed on a hose bib or other threaded element to prevent unauthorized use of the hose bib or threaded element to release water or other fluid. The HBLKRF is comprised of three major elements: an outer member, an inner member and a main body into which a lock is inserted. The lock is operated by a key that is inserted into a key interface. The HBLKRF is designed to be free spinning when in place on a hose bib, and when secured onto a hose bib, the HBLKRF provides a block that prevents water from exiting the hose bib. The HBLKRF is an inventive improvement over previous similar locks/security devices by providing removal of the HBLKRF from a hose bib or other threaded element without the requirement/use of a key. This is accomplished by the use of a removal rod that is inserted into a bore on the main body. From the bore the removal rod continues into the inner member where the rod functions to operate the HBLKRF, which allows the HBLKRF to be removed from the hose bib. The HBLKRF is preferably cylindrical and made of metal, although other shapes and materials can also be utilized, and to increase security a removable cover can be used to hide the location of the bore on the main body. The HBLKRF is beneficial when a key is lost or otherwise unavailable, and is particularly needed in an emergency situation when a key is not available and access to water from a hose bib is immediately required.

### TECHNICAL FIELD

The invention generally pertains to locks that are placed on a hose bib or faucet, and more particularly to a hose bib lock with keyless removal function that can secure a hose bib from un-authorized use and that can be quickly and easily removed from a hose bib without the use of the lock's key.

### BACKGROUND ART

Many buildings, both commercial and residential have outside water faucets. It is also common for there to be interior water faucets in locations that are not secure, i.e., can be easily accessed. A problem exists in that the entire faucet, including water on/off knob and the spigot/bib, is completely exposed. This has led to un-authorized people utilizing the faucet to acquire/use water. When there are multiple people using a faucet (or several faucets) the cost can be significant.

As a result, there are specialized locks that are designed to fit onto/over a faucet spigot/bib to secure the faucet from un-authorized use. Typically, a lock will comprise a housing that screws onto the existing spigot/bob threads. An actual lock within the housing will then maintain the housing securely on the spigot/bib. In order to remove the housing, a key can be inserted which interface with and releases the lock, thereby allowing the housing to be removed from the spigot/bib. As far as functionality, these locks are effective at preventing un-authorized use of a faucet.

As long as the key is readily available a faucet or hose bib lock can be used without a problem. Unfortunately, there are instances when it is extremely necessary to access/use a particular faucet/hose bib with a lock, and the key cannot be located, or the person who has the key is not present. Examples of these instances include a simple case of a gardener or workman requiring water, or, the more serious case of a small fire occurring and having the use of water from a faucet could stop a small fire from become a larger fire.

What is needed is a means by which a faucet lock can be used as intended, but also have the ability to be removed in the event of an emergency or other situation when the key is not available. This ability would also be useful for when a key is simply lost.

Optimally, a faucet/hose bib lock release means would allow a lock to function with no interference. This could be accomplished by adding release functionally that is unobtrusive and can be quickly and easily used without the need for any special tools or devices. The inclusion of emergency (or non-emergency) lock release capability to a faucet lock would provide a safer lock and could potentially save lives and/or property.

A search of the prior art did not disclose any literature or patents that read directly on the claims of the instant invention. However, the following U.S. patents are considered related:

| PATENT NO. | INVENTOR | ISSUED |
|---|---|---|
| 5,176,014 | Erickson | Jan. 5, 1993 |
| 7,287,404 | Nickeas, et al | Oct. 30, 2007 |
| 2009/0025799 | Fraser | Jan. 29, 2009 |

The U.S. Pat. No. 5,176,014 patent discloses a cap that is placed over the pout of a faucet and forms a watertight connection therebetween. Located through the cap is a hole through which a padlock is located. The exterior threaded connection on the spout prevents disengagement of the cap from the faucet. With the cap installed on the spout of the faucet, flow of water through the faucet is prevented.

The U.S. Pat. No. 7,287,404 patent discloses a security device for engaging a threaded element that includes an inner body that engages the threaded element and an outer body coupled to the inner body. A lock engages the outer body which moves with the inner body when the lock is extended and freely rotates relative to the inner body when the lock is retracted.

The 2009/0025799 publication discloses a locking device fort securing a standard hose bib faucet. The device consists of two interlocking pieces of metal that wrap around a faucet in clamshell fashion. Once affixed, a person can then attach a lock to secure the device. The device prevents unauthorized access to the faucet. Because the device also wraps around the connector between the hose and the faucet, theft of an attached hose is only possible by cutting the hose.

For background purposes and indicative of the art to which the invention relates, reference may be made to the following remaining patents found in the patent search.

| PATENT NO. | INVENTOR | ISSUED |
|---|---|---|
| 1,625,901 | Lay | April 1927 |
| 1,702,205 | Freedman | February 1929 |
| 1,702,532 | Boomer, et al | February 1929 |
| 3,426,932 | Rouse | February 1969 |
| 3,605,460 | Singer, et al | September 1971 |
| 3,748,879 | Singer, et al | July 1973 |
| 3,817,065 | Sander | June 1974 |
| 4,122,695 | Hall | 10/1078 |
| 4,516,414 | Woolvin | May 1985 |
| 4,984,698 | Stuckey | January 1991 |
| 5,927,111 | Nachbauer | July 1999 |
| 5,941,103 | Stearns | August 1999 |

### DISCLOSURE OF THE INVENTION

A hose bib lock with keyless removal function (HBLKRF) that is placed on a hose bib to prevent an unauthorized person from using the hose bib to release water.

The HBLKRF is comprised of three major elements: an outer member, an inner member and a main body into which a lock is inserted. Additionally, the HBLKRF can also include a gasket between the hose bib and the inner member. The gasket prevents particulates and liquid from escaping/exiting the hose bib even when the hose bib is operated. The lock is operated by a key that is inserted into a key interface. The HBLKRF is designed to be free spinning when in place on a hose bib, and when secured onto a hose bib, the HBLKRF provides a block that prevents water from exiting the hose bib.

The HBLKRF is an improvement over previous similar locks/security devices. The inventive improvement is the keyless removal which allows the HBLKRF to be quickly and easily removed from a hose bib without the requirement/use of a key. This is accomplished by the use of a removal rod that is within a bore on the main body. From the bore the removal rod can be pushed into the inner member where the rod functions to operate the HBLKRF, which allows the HBLKRF to be removed from the hose bib. The HBLKRF is preferably cylindrical and made of metal, although other shapes and materials can also be utilized.

The HBLKRF is beneficial when a key is lost or otherwise unavailable, and is particularly needed in an emergency situation when a key is not available and access to water from a hose bib is immediately required. In addition to being used to secure a hose bib, the HBLKRF can be used on many other items that have a threaded element.

In view of the above disclosure, the primary object of the invention is to provide a hose bib lock with keyless removal function that can be secured onto a hose bib to prevent the unauthorized access to water from the hose bib and can be quickly and easily removed form a hose bib without requiring the use of a key.

In addition to the primary object, it is also an object of the invention to provide a hose bib lock with keyless removal function that:
is easy to use,
does not interfere with the operation of a hose bib,
can be made in various sizes to fit on different hose bibs,
can be used indoors or outdoors,
has few moving parts which results in greater durability,
is robust and long-lasting,
can be sold as an after-market product or as an OEM product with a hose bib or faucet,
increases the safety when using a hose bib lock, and
is cost effect from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is an orthographic side view showing a hose bib lock with keyless removal function (HBLKRF).

FIG. 2 is an orthographic top view showing the HBLKRF.

FIG. 3 is an elevational view showing the HBLKRF.

FIG. 4 is a cut-away view showing the HBLKRF.

FIG. 5 is an orthographic view showing the HBLKRF secured on a hose bib.

FIG. 6 is an orthographic view showing the HBLKRF secured on a hose bib with a removal rod inserted into a bore on the HBLKRF main body.

FIG. 7 is an orthographic view showing the HBLKRF secured on a hose bib with a removal rod inserted into the bore on the HBLKRF main body.

FIG. 8 is an orthographic top view showing the HBLKRF with a key inserted.

FIG. 9 is an exploded view showing the HBLKRF major elements including an outer member, an inner member and a main body, as well as a gasket, a lock with key and a removal rod.

FIG. 10 is an elevational view showing the HBLKRF with a key inserted.

FIG. 11 is a cut-away view showing the HBLKRF with a key inserted.

FIG. 12 is an orthographic view showing the HBLKRF secured to a hose bib with the key inserted.

### BEST MODE FOR CARRYING OUT THE INVENTION

The best mode for carrying out the invention is presented in terms that disclose a preferred embodiment of a hose bib lock with keyless removal function (HBLKRF 10). Note: this patent application should be viewed as an improvement upon the applicant's previously issued U.S. patent (U.S. Pat. No. 7,287,404B2). The improvement consists of the keyless removal function which, as the name implies, allows the lock to be removed from a hose bib or other threaded element, without being obvious and not requiring the use of a key. This keyless removal significantly increases and improves the functionality of the previous lock which required a key for removal or dismembering the faucet lock from the hose bid or other threaded element.

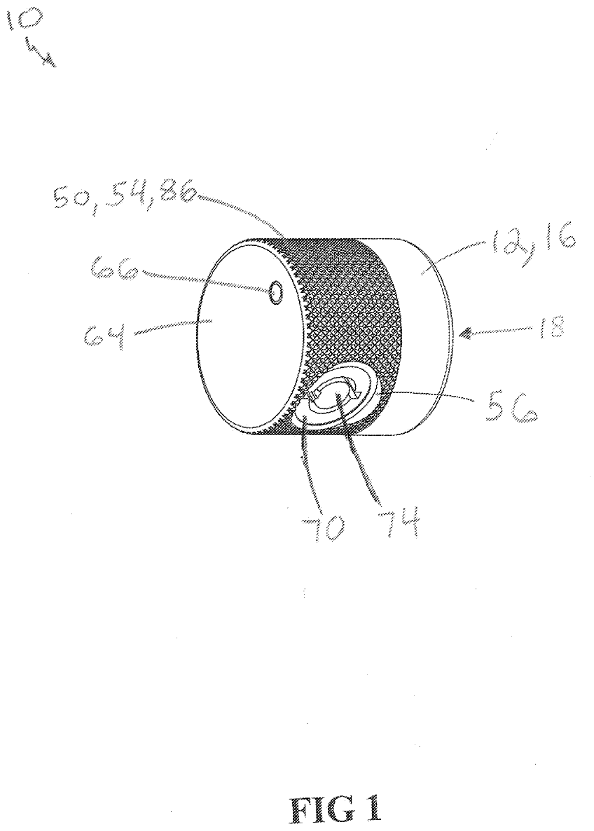

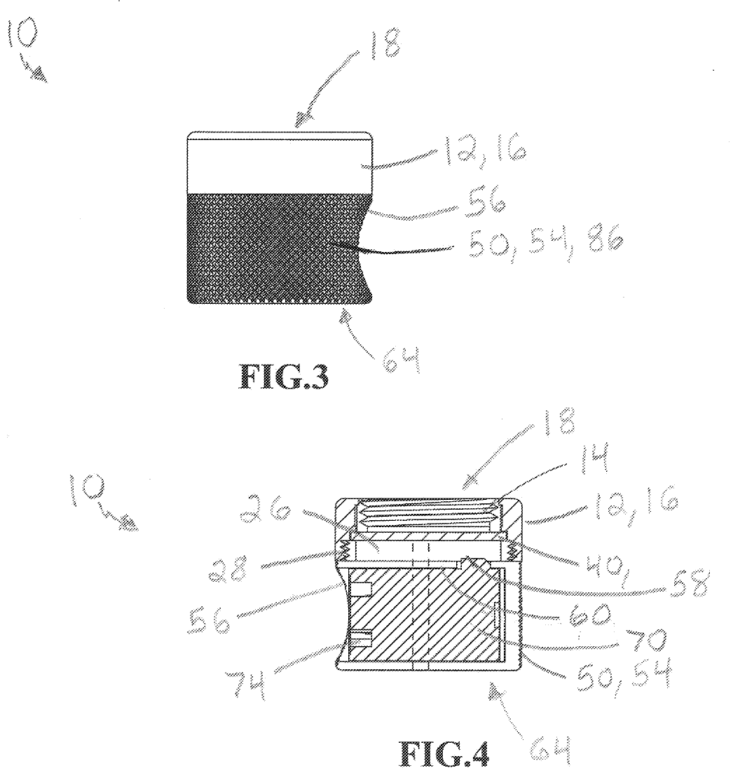

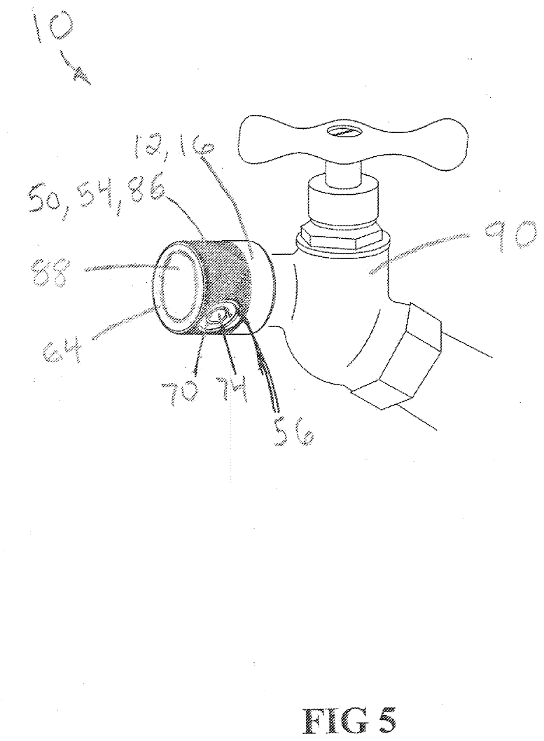

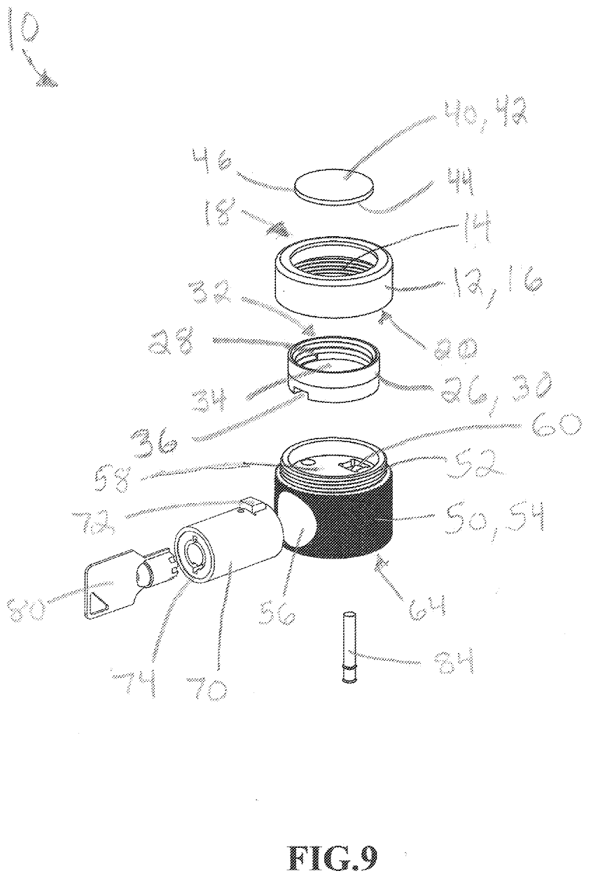

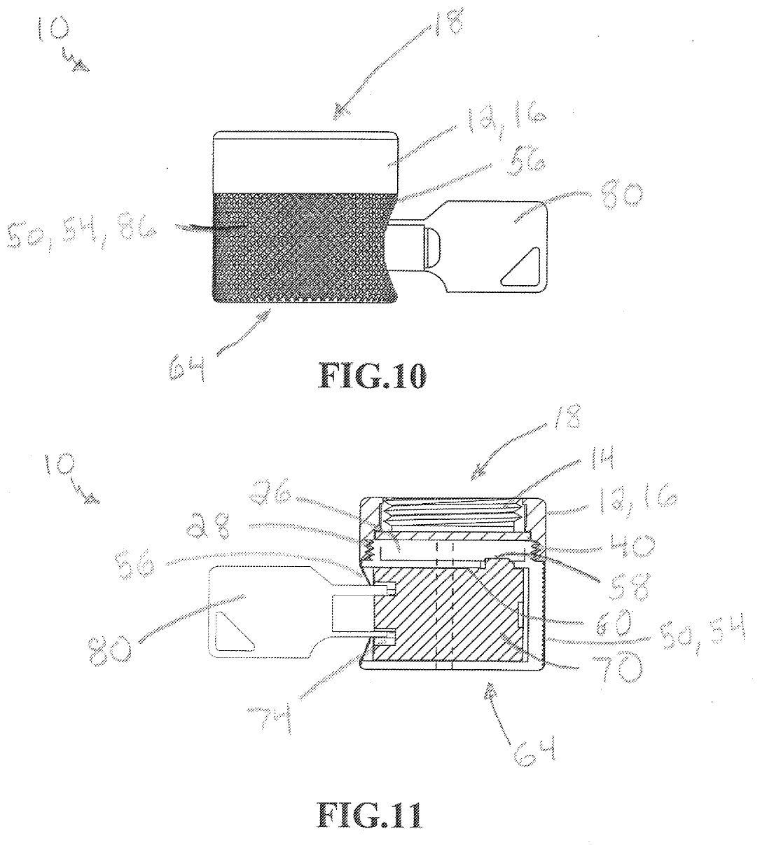

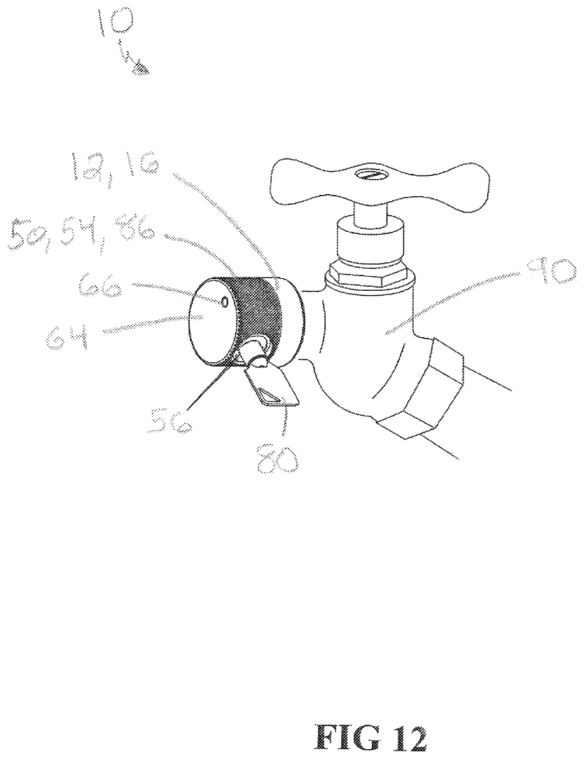

The HBLKRF 10, as shown in FIGS. 1-12, is comprised of the following major elements: an outer member 12, an inner member 26 and a main body 50. As shown in FIGS. 5-7 and 12, the HBLKRF 10 is used on a hose bib 90 (or faucet). The outer member 12, inner member 26 and main body 50 are all preferably cylindrical, although other shapes could be utilized, and are made of metal such as brass, plastic or a composite.

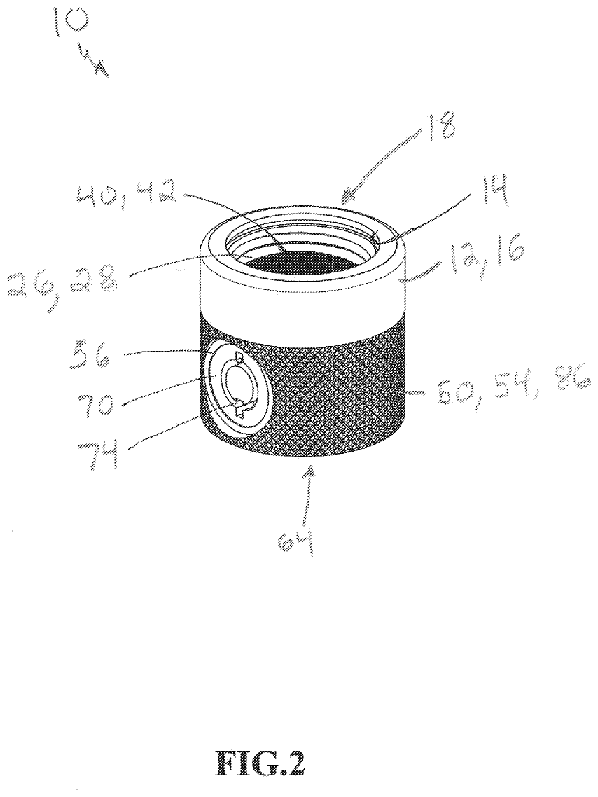

The outer member 12, as shown in FIGS. 1-12, is comprised of a threaded inner surface 14, an outer surface 16, a first opening 18, and a second opening 20. The inner member 26, as shown in FIGS. 2, 4, 8, 9 and 11, is comprised of a threaded inner surface 28, an outer surface 30, a first opening 32, a second opening 34, and a notch 36 extending through from the outer surface 30.

The main body 50, as shown in FIGS. 1-12, is comprised of an upper threaded section 52, an outer side wall 54 having an opening 56, an inner first surface 58 having a lock engagement opening 60, and an outer second surface 64 having a bore 66 containing a removal rod 84.

As shown in FIGS. 4, 9 and 11, a gasket 40 with an outer surface 42, an inner surface 44 and a perimeter edge 46 can be configured between the hose bib 90 and the inner member 26. The gasket 60 creates a seal between the inner member 20 and the hose bib 90 to prevent fluid from escaping/exiting the hose bib even if the hose bib 90 is operated. The gasket 60 can be made from any suitable material such as rubber, plastic, metal or a composite.

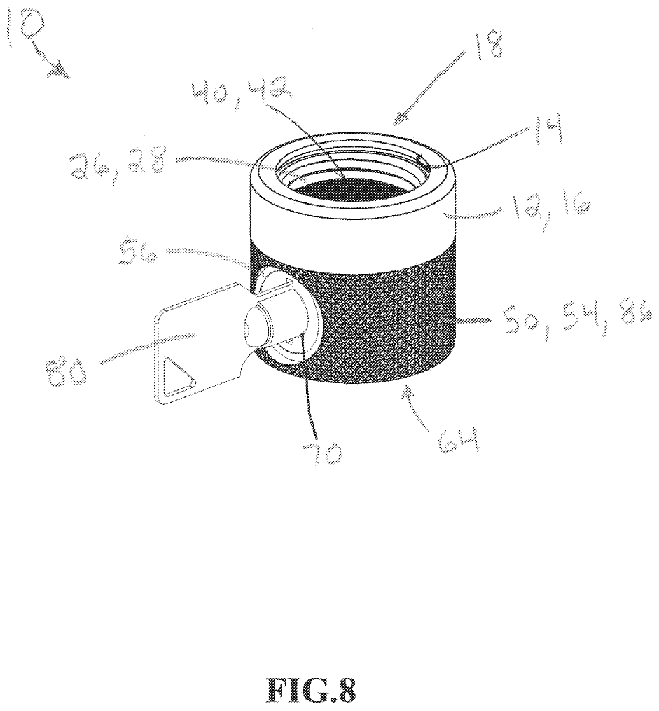

As shown in FIGS. 1, 2, 5-9 and 11, inserted into the main body 50 via the outer side wall opening 56, is a lock 70, which is also preferably cylindrical and includes an engagement member 72 and a key interface 74. The lock 70 is operated by a key 80, as shown in FIGS. 8-12, that is inserted into the key interface 74. While a cylindrical lock 70 is preferred, many types of locks can be utilized such as tubular, flat key or digital/electronic.

Both the outer member 12 and the inner member 26 are maintained together with the main body 50. When the HBLKRF 10 is placed on a hose bib 90 in a secured configuration, the lock 70, by means of the engagement member 74, is in an unsecured configuration. The lock 70 engagement member 72 is in an outward extended position, with the engagement member 72 extending from a side of the lock 70 through the outer body 12 and then engaging the inner body 26. In the unsecured configuration, the outer member 12, as a result of the extended engagement member 72 engaging, also causes rotation of the inner body 26. In the secure configuration, the engagement member 72 is retracted inside the lock 70 and out of engagement with the inner member 26. Therefore, the outer member 12 can rotate freely relative to the inner member 26, but rotation of the outer member 12 will not cause the inner member 26 to rotate. To prevent access to the inner member 26 when the HBLKRF 10 is in the secure configuration, the main body 50 is freely rotatably mounted to the inner member 26. The main body 50 can rotate relative to the inner member 26, whether the lock 70 is in the extended position or the retracted position.

The HBLKRF 10 prevents unauthorized use of a hose bib 90 by preventing water from exiting the hose bib 90. To lock a hose bib 90 with the HBLKRF 10, a person will place the HBLKRF 10 on a hose bib 90 in the unsecured configuration. The HBLKRF 10 is then screwed onto the hose bib 90 by having the inner member threaded inner surface 28 interface with a threaded section of the hose bib 90.

There is no requirement that the engagement member 72 be aligned prior to actuation of the lock 70 because the HBLKRF 10 automatically aligns itself. Once the engagement member 72 has been actuated by the key 80 to the extended position, a person only needs to rotate the outer member 12 relative to the inner member 26 and the engagement member 72 will automatically engage.

Once the inner member 26 is connected to the hose bib 90 the HBLKRF 10 is not necessarily in the secured configuration. When the lock 70 is in the unsecured configuration the engagement member 72 extends outward from the lock 70 to engage the inner body 26. Any rotation of the outer body 12 causes rotation of the inner body 26, allowing the HBLKRF 10 to be unsecured from the hose bib 90. To place the HBLKRF 10 in the secured configuration, a person can turn the key 80 so that the engagement member 72 retracts inside the lock 70. The outer member 12 can then rotate relative to the inner body 26 if an unauthorized user attempts to remove the HBLKRF 10 by simply unscrewing the HBLKRF 10 from the hose bib. When this occurs, both the outer member 12 and the main body 50 freely spin relative to the inner member 26. Therefore, the rotation of the outer member 12 and/or the main body 50 will not cause the inner member 26 to rotate relative to the hose bib 90 which would not allow the HBLKRF 10 to be unscrewed from the hose bib 90.

When the HBLKRF10 is placed on a hose bib 90 in the secured configuration, any attempt by an unauthorized person to operate the hose bib 90 will cause the rotation of the outer member 12 and the main body 50 about the hose bib 90, therefore preventing water from exiting the hose bib 90.

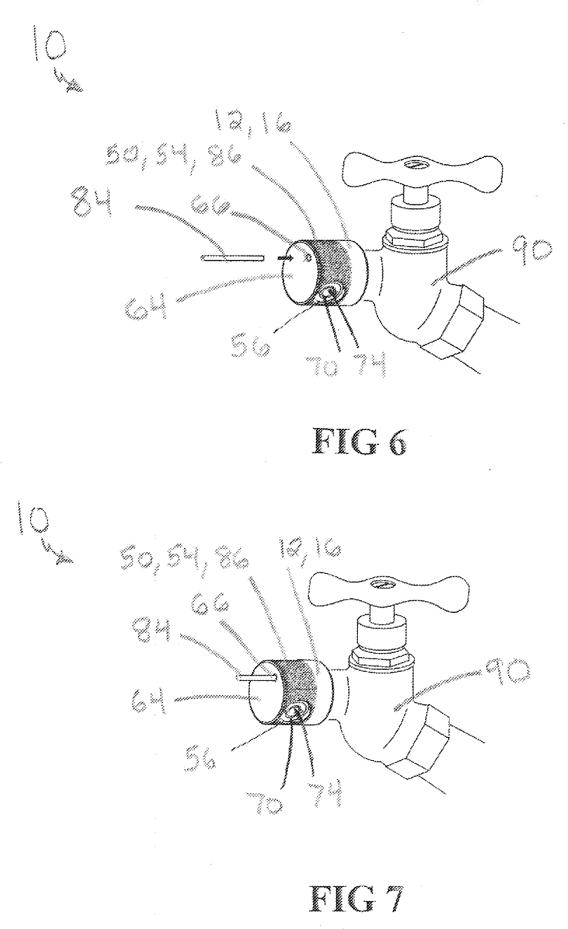

The inventive improvement of the HBLKRF 10 over the previous lock/security device, is the ability to use the removal rod 84, as shown in FIGS. 6 and 7, to remove the HBLKRF 10 from a hose bib 90 without the requirement of the key 80. In order to remove the HBLKRF 10 without the key 80, the removal rod 84 within the bore 66 on the main body outer second surface 64 can be revealed by removing a cover 88. Basically, if the HBLKRF 10 becomes inoperable, a rigid object having a diameter smaller than the bore 66 can be used to push the rod 84 inward into the bore 66. While pushing the rod 84 inward the outer member of the HBLKRF 10 should be rotated in either direction until the rod 84 is correctly seated within an inner member slot. Once the rod 84 is correctly seated, the HBLKRF 10 can be removed by counter-clockwise rotation.

While the operation of the keyless removal may seem simple, the ability significantly improves the functionality of the HBLKRF10. The ability to remove the HBLKRF 10 without a key also improves safety. For example, if a small fire occurs and water is needed to extinguish the fire. If there is a hose bib in the vicinity with a lock/securely device on it, as long as the key is readily available there is no problem. But if the key is lost or otherwise not available, the ability to quickly and easily remove the HBLKRF 10 can result in a small fire not being extinguished, or potentially a small fire turning into a large conflagration.

In order to hide and protect the removal rod bore 66, the cover 88, as shown in FIG. 5, can be removably attached onto the main body outer second surface 64. The cover 88 preferably comprises a non-permanent adhesive backed material. Also, to provide a better grip on the main body 50, the outer surface can be knurled 86, as shown in FIGS. 1-3, 5-8, 10 and 12.

In should be noted that while the HBLKRF 10 is primarily designed to be used on a conventional hose bib 90, the HBLKRF 10 can be attached to any type of apparatus, device, assembly or other structure with a threaded element. For example, the HBLKRF 10 can be attached onto a beverage container, a chemical container, or residential/commercial piping. Also, the removal rod 84 can be any shape/size as long as the bore 66 is dimensioned to accept the rod 84.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A hose bib lock with keyless removal function comprising:
an outer member,
an inner member configured to interface with a threaded element,
a gasket.
a main body disposed over and rotatable about the outer member and inner member,
a lock configured to be inserted into an opening on the main body, the lock maintaining the HBLKRF in a retracted secured configuration or an extended unsecured configuration,
a key to release the lock from the secured configuration to the unsecured configuration, and
a removal rod that is within a bore on an outer second surface of the main body, the rod interfaced with the lock to facilitate the removal of the HBLKRF without the use of the key.

2. The hose bib lock with keyless removal function of claim 1, wherein the HBLKRF is made of metal.

3. The hose bib lock with keyless removal function of claim 1, wherein the HBLKRF is made of plastic.

4. The hose bib lock with keyless removal function of claim 1, wherein the HBLKRF is made of composite.

5. The hose bib lock with keyless removal function of claim 1, wherein the HBLKRF is secured to a threaded element.

6. The hose bib lock with keyless removal function of claim 1, wherein the lock is selected from the group consisting of a tubular lock, a flat-key lock and a digital/electronic lock.

7. The hose bib lock with keyless removal function of claim 1, further comprising a knurled surface on an outer surface of the main body.

8. The hose bib lock with keyless removal function of claim 1, further comprising a cover that is removably attached onto the main body outer second surface to hide and protect the bore.

9. The hose bib lock with keyless removal function of claim 7, wherein the cover comprises a non-permanent adhesive backed material.

10. A hose bib lock with keyless removal function comprising:
an outer member having:
a threaded inner surface,
an outer surface,
a first opening,
a second opening,
an inner member configured to engage a hose bib and coupled to the outer ember, the inner member having:
a threaded inner surface,
an outer surface with a notch,
a first opening,
a second opening,
a gasket disposed between the outer member and inner member, with:
an outer surface,
an inner surface,
an perimeter edge,
a main body disposed over and rotatable about the outer member and inner member, the main body having:
an upper threaded section,
an outer side wall having an opening,
an inner first surface having a lock engagement opening,
an outer second surface having a bore,
a lock disposal within the main body, the lock including a key interface and an engagement member that is movable from a secured retracted position to an unsecured extended position,
a key that releases the lock from the retracted position to the extended position, thereby allowing removal of the HBLKRF, and
a removal rod within the bore on the main body outer second surface, the rod is pushed inward to interface the main body with the inner member, thereby allowing removal of the HBLKRF without the use of the key.

11. The hose bib lock with keyless removal function of claim 10, wherein the HBLKRF is made of metal.

12. The hose bib lock with keyless removal function of claim 10, wherein the HBLKRF is made of plastic.

13. The hose bib lock with keyless removal function of claim 10, wherein the HBLKRF is made of composite.

14. The hose bib lock with keyless removal function of claim 10, wherein the HBLKRF is secured to a threaded element.

15. The hose bib lock with keyless removal function of claim 10, wherein the lock is selected from the group consisting of a tubular lock, a flat-key lock and a digital/electronic lock.

16. The hose bib lock with keyless removal function of claim 10, further comprising a knurled surface on an outer surface of the main body.

17. The hose bib lock with keyless removal function of claim 10, further comprising a cover that is removably attached onto the main body outer second surface to hide and protect the bore.

18. The hose bib lock with keyless removal function of claim 17, wherein the cover comprises a non-permanent adhesive backed material.
